(19) United States
(12) Patent Application Publication
(10) Pub. No.: US 2011/0052405 A1
(43) Pub. Date: Mar. 3, 2011

(54) COMPOSITE AIRFOIL WITH LOCALLY REINFORCED TIP REGION

(75) Inventor: Michael Parkin, S. Glastonbury, CT (US)

(73) Assignee: UNITED TECHNOLOGIES CORPORATION, Hartford, CT (US)

(21) Appl. No.: 12/552,753

(22) Filed: Sep. 2, 2009

(51) Int. Cl. F01D 5/14; B29C 39/02

(52) U.S. Cl. 416/230; 264/299

(57) ABSTRACT

A composite airfoil has a root, a tip, a root region and a tip region. The composite airfoil further includes a woven core, a first filament reinforced airfoil ply, a second filament reinforced airfoil ply and a local reinforcement laminate section. The woven core extends from the root to the tip of the composite airfoil. The first filament reinforced airfoil ply is stacked on the woven core and the second filament reinforced airfoil ply is stacked adjacent to the first filament reinforced airfoil ply on the woven core. The local reinforcement laminate section is at the tip region of the composite airfoil and comprises a first reinforcement ply that does not extend to the root region. The local reinforcement laminate section increases a chordwise flexural stiffness of the tip region.

### BACKGROUND

Composite materials offer potential design improvements in gas turbine engines. For example, in recent years composite materials have been replacing metals in gas turbine engine fan blades because of their high strength and low weight. Most metal gas turbine engine fan blades are titanium. The ductility of titanium fan blades enables the fan to ingest a bird and remain operable or be safely shut down. The same requirements are present for composite fan blades.

A composite airfoil for a turbine engine fan blade can have a sandwich construction with a carbon fiber woven core at the center and two-dimensional filament reinforced plies or laminations on either side. To form the composite airfoil, individual two-dimensional plies are cut and stacked in a mold with the woven core. The mold is injected with a resin using a resin transfer molding process and cured. The plies vary in length and shape. The carbon fiber woven core is designed to accommodate ply drops so that multiple plies do not end at the same location.

Each ply comprises a plurality of oriented elongated fibers. For example, a ply can comprise a woven material or a uniweave material. With a woven material, half of the woven fibers are oriented in a first direction and half the fibers are oriented in a direction 90° from the first direction. A uniweave material, on the other hand, has about 98% of its fibers oriented in a first direction and a small number of fibers extending in a direction 90° from the first direction to stitch the uniweave material together.

Previous composite blades have been configured to improve the impact strength of the composite airfoils so they can withstand bird strikes. During use, foreign objects ranging from large birds to hail may be entrained in the inlet of the gas turbine engine. Impact of large foreign objects can rupture or pierce the blades and cause secondary damage downstream of the blades. There are design drivers in addition to the ability to withstand bird strikes which will improve composite blades.

### SUMMARY

A composite airfoil has a root, a tip, a root region and a tip region. The composite airfoil further includes a woven core, a first filament reinforced airfoil ply, a second filament reinforced airfoil ply and a local reinforcement laminate section. The woven core extends from the root to the tip of the composite airfoil. The first filament reinforced airfoil ply is stacked on the woven core and the second filament reinforced airfoil ply is stacked adjacent to the first filament reinforced airfoil ply on the woven core. The local reinforcement laminate section is at the tip region of the composite airfoil and comprises a first reinforcement ply that does not extend to the root region. The local reinforcement laminate section increases a chordwise flexural stiffness of the tip region.

### BRIEF DESCRIPTION OF THE DRAWINGS

FIG. 1 is a cross-sectional view of a gas turbine engine.

FIG. 2 is a front view of a pressure side of a composite fan blade having a composite airfoil with a locally reinforced tip region.

FIG. 3 is a cross-sectional view of the composite airfoil of FIG. 2 taken along line 3-3.

FIG. 4 is an exploded schematic view of a lay-up for the pressure side of the composite airfoil of FIGS. 2 and 3 having the locally reinforced tip region.

FIG. 5 is an exploded schematic view of an alternative lay-up for the pressure side of the composite airfoil of FIGS. 2 and 3 having the locally reinforced tip region.

FIG. 6 is an enlarged cross-sectional view of the composite airfoil of FIGS. 2 and 3 having a core with a recess.

### DETAILED DESCRIPTION

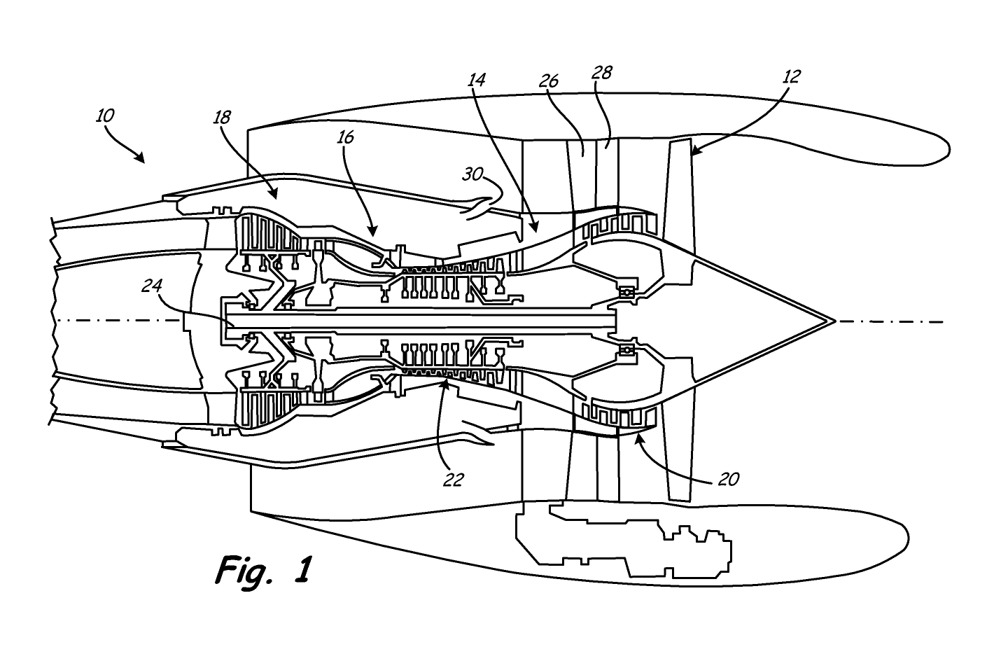

FIG. 1 is a cross-sectional view of gas turbine engine 10, which includes turbofan 12, compressor section 14, combustion section 16 and turbine section 18. Compressor section 14 includes low-pressure compressor 20 and high-pressure compressor 22. Air is taken in through fan 12. Fan 12 spins and takes in a large amount of inlet air. A portion of the inlet air is directed to compressor section 14 where it is compressed by a series of rotating blades and vanes. The compressed air is mixed with fuel, and then ignited in combustor section 16. The combustion exhaust is directed to turbine section 18. Blades and vanes in turbine section 18 extract kinetic energy from the exhaust to turn shaft 24 and provide power output for engine 10.

The portion of inlet air which is taken in through fan 12 and not directed through compressor section 14 is bypass air. Bypass air is directed through bypass duct 26 by guide vanes 28. Then the bypass air flows through opening 30 to cool combustor section 16, high pressure combustor 22 and turbine section 18.

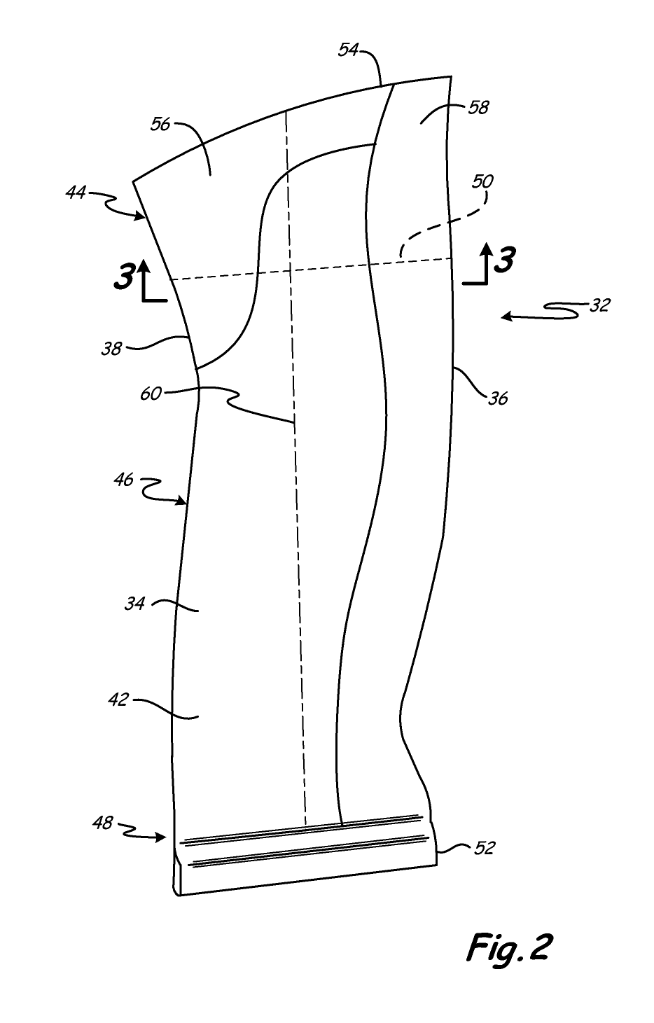

Turbofan 12 comprises a plurality of composite blades, such as composite blade 32 shown in FIG. 2. Composite blade 32 includes composite airfoil 34 (having leading edge 36, trailing edge 38, suction side 40 (not shown), pressure side 42, tip region 44, intermediate region 46, root region 48, local reinforcement laminate region 50, root 52 and tip 54), protective tip 56, protective leading edge 58 and longitudinal axis 60. Root 52 is illustrated as a dovetail root. However, root 52 can have any configuration. Longitudinal axis 60 extends from root region 48 to tip region 44.

Composite airfoil 34 extends from root 52. The span of composite airfoil 34 is generally defined along longitudinal axis 60. Root region 48 of composite airfoil 34 is proximate root 52, tip region 44 is proximate tip 54 and opposite root region 48, and intermediate region 46 is between root region 48 and tip region 44. In one example, tip region 44 extends between about 80% of the span-wise extension of composite blade 32 (as measured from root 52 to tip 54) and tip 54, such that tip region 44 has a length equal to about 20% of the span-wise extension of blade 32.

Local reinforcement laminate region 50 is located at tip region 44 of composite airfoil 34. Local reinforcement laminate section 50 locally reinforces tip region 44 of composite airfoil 34. Local reinforcement laminate section 50 is limited to tip region 44 and does not extend to root region 48. In one example, local reinforcement laminate section 50 extends less than or equal to about 20% of the span-wise extension of airfoil 34.

Local reinforcement laminate region 50 comprises at least one filament reinforced ply configured to increase the chordwise stiffness of tip region 44. For example, the composition or the fiber orientation of the ply of local reinforcement laminate region 50 can be configured to increase the chordwise stiffness of tip region 44. As described further below, local reinforcement laminate region 50 reduces or eliminates blade flutter.

Protective tip 56 is located along tip 54 and protective leading edge 58 is located along leading edge 36 of composite airfoil 34. Protective tip 56 and protective leading edge 58 protect composite airfoil 34 from damage caused by, for example, bird strikes. Protective tip 56 and protective leading edge 58 also protect composite airfoil 34 from erosion caused by sand, pebbles and other abrasive materials ingested by the turbine during operation. In one example, protective tip 56 and protective leading edge 58 are formed of titanium. Typically, protective tip 56 and protective leading edge 58 are attached to composite airfoil 34 after composite airfoil 34 has been cured and shaped.

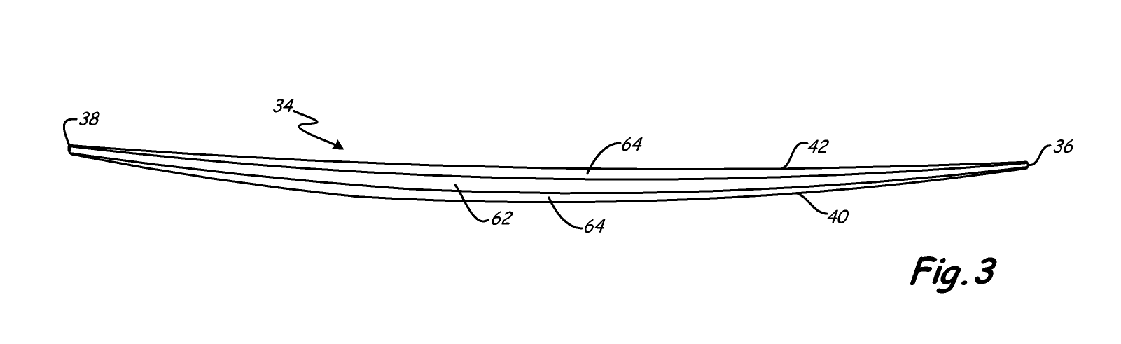

FIG. 3 is a cross-sectional view of composite airfoil 34 taken along line 3-3 of FIG. 2. As illustrated in FIG. 3, composite airfoil 34 has a sandwich configuration and includes woven core 62 and filament reinforced airfoil laminations or plies 64. Woven core 62 is located at the center of composite airfoil 34 and extends along longitudinal axis 60 between root region 48 to tip region 44. Woven core 62 is a three-dimensional woven core containing, for example, carbon fiber.

Airfoil plies 64 are located on either side of woven core 62. Airfoil plies 64 are two-dimensional fabric skins. Elongated fibers extend through airfoil plies 64 at specified orientations and give airfoil plies 64 strength. Airfoil plies 64 vary in shape, size and fiber orientation as described further below. Airfoil plies 64 can be a dry fabric that is combined with a resin in a suitable mold and cured to form composite airfoil 34. Alternatively, airfoil plies 64 can be preimpregnated uncured composites, (i.e. “prepregs”) in which fibers and a resin are combined with a suitable curing.

Turbofan blade designs are primarily driven by three factors: efficiency, protection against bird strike impacts and reducing blade flutter. As described above, turbofan 12 can ingest foreign objects ranging in size from a large bird to hail. Such objects can cause foreign object damage (FOD). Composite fan blades are designed to protect against bird strike impacts and prevent damage to engine 10. In composite airfoil 34, woven core 62 absorbs damage due to bird strikes, and airfoil plies 64 provide additional in-plane strength, particularly at root region 48. Composite airfoil 34 is designed to have reduced or eliminated blade flutter. Blade flutter is characterized by the flapping or vibrating of tip region 44 of composite fan blade 32. Blade flutter is an aerodynamic phenomenon that is dependent on both the aerodynamic and the structural characteristics of the composite fan blade 32. Locally reinforcing tip region 44 of composite airfoil 34 with local reinforcement laminate region 50 enables composite fan blade 32 to be tuned. By adjusting the stiffness of composite airfoil 34 along the chordwise axis (i.e. the chordwise stiffness) using local reinforcement laminate region 50, blade flutter can be reduced or eliminated. The chordwise axis is perpendicular to longitudinal or spanwise axis 60. The chordwise axis spans between leading edge 36 and trailing edge 38.

Composite airfoil 34 is formed by stacking airfoil plies 64 on woven core 62. Airfoil plies 64 are stacked in a mold on either side of woven core 62 according to a ply lay-up. Typically the ply lay-up on the pressure side of woven core 62 is a mirror image of the ply lay-up on the suction side of woven core 62. Once all airfoil plies 64 are properly stacked, the mold is closed, resin is added and the resin is cured to produce composite airfoil 34. After curing, material can be removed from root region 48 of composite airfoil 34 to further shape root region 48, and protective tip 56 and protective leading edge 58 (shown in FIG. 2) can be attached to composite airfoil 34. In an alternative example, airfoil plies 64 contain resin so that resin is not directly added to airfoil plies 64 after stacking them in the mold.

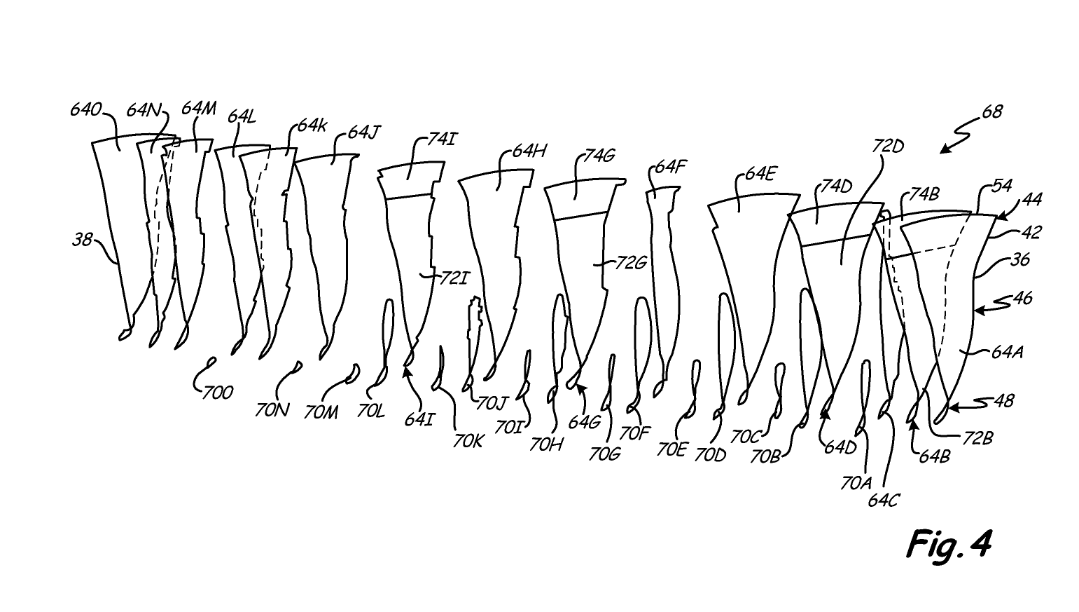

FIG. 4 is an exploded schematic view of ply lay-up 68 having locally reinforced region 50 formed by replacing tip region 44 of select airfoil plies 64 with reinforcement plies. Ply lay-up 68 is for pressure side 42 of composite airfoil 34 and comprises filament reinforced airfoil plies 64A-64O and filament reinforced root plies 70A-70O. Airfoil plies 64A-64O (referred to generally as airfoil plies 64) form pressure side of composite airfoil 34 of FIGS. 2 and 3. Airfoil ply 64A is the outermost ply on pressure side 42. Airfoil ply 64O is the innermost ply and is adjacent woven core 62 (not shown in FIG. 4). Ply lay-up 68 is the lay-up for pressure side plies 64 located between woven core 62 and pressure side 42 of composite airfoil 34. The lay-up for plies 64 located between woven core 62 and suction side 40 is a minor image of ply lay-up 68.

Airfoil ply 64B is a locally reinforced ply that comprises two pieces: primary ply 72B and reinforcement ply 74B. Primary ply 72B extends between root region 48 and a location within or proximate to tip region 44. Reinforcement ply 74B is aligned with and extends from the end of primary ply 72B. Reinforcement ply 74B extends along the longitudinal axis between the end of primary ply 72B and a location within tip region 44. Reinforcement ply 74B may not extend to tip 54.

Reinforcement ply 74B has a different composition, a different fiber orientation or a different composition and a different fiber orientation than primary ply 72B. For example, reinforcement ply 74B can have a 90° fiber orientation and primary ply 72B can have a 0° fiber orientation. Reinforcement ply 74B is configured to increase the chordwise stiffness of tip region 44 of composite airfoil 34. In one example, reinforcement ply 74B and primary ply 72B have approximately the same thickness so that when stacked in ply lay-up 68, no tooling changes are required and composite airfoil 32 has the same geometry as a composite airfoil without reinforcement ply 74B. When reinforcement ply 74B has the same thickness as primary ply 72B, reinforcement ply 74B does not add additional thickness and an existing mold can be used to produce composite airfoil 34 having an increased chordwise stiffness. Alternatively, woven core 62 can be configured to compensate for a difference in thickness between reinforcement ply 74B and primary ply 72B. For example, as described further below, woven core 62 can be formed with a recess at tip region 44 having the same shape and size as additional thickness created by local reinforcement laminate region 50.

Plies 64D, 64G and 64I have configurations similar to ply 64B. Plies 64B, 64D, 64G and 64I are locally reinforced plies formed from primary plies and reinforcement plies. Together reinforcement plies 74B, 74D, 74G and 74I form local reinforced region 50 at tip region 44 of composite airfoil 34.

Root plies 70A-70O (referred to generally as root plies 70) are inserted between sections of airfoil plies 64 and form a portion of root region 48 of composite airfoil 34. Root plies 70 extend between root region 48 and intermediate region 46. Root plies 70 do not extend into tip region 44. Root plies 70 provide strength and bending stiffness at root region 48 which enables composite blade 32 to withstand aerodynamic loads and loads generated by bird strikes.

Airfoil plies 64 and root plies 70 can be formed from the same material or from different materials. For example, airfoil plies 64 can be formed from a woven fabric or a uniweave material, and root plies 70 can be formed from a uniweave material. In a woven fabric, half of the fibers are orientated in a first direction and the other half of the fibers are oriented 90° to the first direction. For example, half of the fibers of a 0/90° woven fabric are oriented along the longitudinal axis and the other half of the fibers are oriented along the chordwise axis, perpendicular to the longitudinal axis. Similarly, half of the fibers of a +/−45° woven fabric are oriented at +45° from the longitudinal axis and the other half of the fibers are oriented at −45° from the longitudinal axis. The woven fabric can be a carbon woven fabric, such as a carbon woven fabric containing IM7 fibers, to which resin is added to form a composite. In one example, the woven fabric is a 5 hardness satin (5HS) material. Alternatively, the woven fabric can be a prepreg. In a prepreg material, the fibers, resin, and a suitable curing agent are combined. Further, the prepreg material can be a hybrid prepreg which contains two different types of fibers and an epoxy. Example prepreg hybrids include hybrids containing an epoxy and two different types of carbon fibers, such as low modulus carbon fibers (modulus of elasticity below about 200 giga-Pascals (GPa)), standard modulus carbon fibers (modulus of elasticity between about 200 GPa and about 250 GPa), intermediate modulus carbon fibers (modulus of elasticity between about 250 GPa and about 325 GPa) and high modulus carbon fibers (modulus of elasticity greater than about 325 GPa). In one example, the prepreg hybrid is a standard modulus carbon fiber/high modulus carbon fiber/epoxy hybrid. Example prepreg hybrids also include carbon fibers/boron fibers/epoxy hybrid prepregs.

In contrast to woven materials, a uniweave material has about 98% of its fibers oriented along the longitudinal axis of airfoil 34. A small number of fibers extend perpendicular to the longitudinal axis and stitch the uniweave material together.

The fiber orientation affects the strength of the material. For example, a composite formed of a 0/90° 5HS woven fabric has a modulus of approximately 75 giga-Pascals (GPa) (11 million pounds per square inch (msi)) in both the 0° and 90° directions, where 0° represents the represents the longitudinal axis (span direction) of airfoil 34. In comparison, a composite formed of a 0° uniweave material comprising the same fibers has a modulus of approximately 165 GPa (24 msi) in the 0° direction and approximately 9.6 GPa (1.4 msi) in the 90° direction.

In FIG. 4, tip region 44 of four pressure side airfoil plies, airfoil plies 64B, 64D, 64G and 64I, include reinforcement plies 74B, 74D, 74G and 74I to reinforce tip region 44. Airfoil plies 64B, 64D, 64G and 64I are locally reinforced plies while airfoil plies 64A, 64C, 64E, 64F, 64H and 64J-64O are non-locally reinforced plies. In one example, airfoil plies 64A, 64F, 64J, 64L and 64N are 0/90° 5HS woven material; airfoil plies 64C, 64K and 64M and root plies 70 are 0° uniweave material; and airfoil plies 64E, 64H and 64O are +/−45° 5HS woven material. Airfoil plies 64B, 64D, 64G and 64I comprise primary plies 72B, 72D, 72G and 72I, respectively, at root region 48 and reinforcement plies 74B, 74D, 74G and 74I, respectively, at tip region 44. Airfoil plies 64B, 64D, 64G and 64I have a different material at root region 48 than at tip region 44. Primary plies 72B, 72D, 72G and 72I are formed from 0/90° 5HS woven material, and reinforcement plies 74B, 74D, 74G and 74I are formed from 90° uniweave. Root plies 70 are formed of 0° uniweave material to provide stiffness along the longitudinal axis at root region 48. At mid-chord at tip 54, airfoil plies 64 each have a thickness of about 0.26 millimeters (0.01 inches) and woven core 62 (not shown) has a thickness of about 2.31 millimeters (0.09 inches). The plies on the concave or suction side of woven core 62 have a similar configuration, and airfoil 34 has a total thickness of about 10.2 millimeters (0.4 inches). The flexural stiffness of composite airfoil 34 along longitudinal axis 60 (the spanwise stiffness) is about 64.1 GPa (9.3 msi) and the flexural stiffness of composite airfoil 34 in the direction perpendicular to longitudinal axis 60 (the chordwise stiffness) is about 92.3 GPa (13.4 msi), where the flexural stiffness is the flexural stiffness at mid-chord of the tip region and was determined using finite element modeling software.

In comparison, a composite airfoil having a layup similar to layup 68 of FIG. 4 except having single piece airfoil plies 64B, 64D, 64G and 64I, such that airfoil plies 64B, 64D, 64G and 64I are formed entirely from 0/90° 5HS woven material, has a spanwise flexural stiffness of about 88.3 GPa (12.8 msi) and a chordwise flexural stiffness of about 61.0 GPa (8.9 msi), where the flexural stiffness is the flexural stiffness at mid-chord of the tip region and was determined using finite element modeling software. Locally reinforcing tip region 44 by replacing a portion airfoil plies 64B, 64D, 64G and 64I with local reinforcement plies 74B, 74D, 74G and 74I results in a 27% decrease in the spanwise flexural stiffness of airfoil 34 and a 51% increase in the chordwise flexural stiffness. That is, local reinforcement laminate region 50 increases the chordwise flexural stiffness of composite airfoil 34 compared to a composite airfoil not having local reinforcement lamination region 50 and having airfoil plies 64 having a uniform composition from root to tip.

Previous fan blades were formed from a metal, such as titanium. Metals are typically isotropic in nature so that the stiffness properties are generally the same in every direction. In contrast, the stiffness properties of a composite material can differ greatly depending on the orientation of the fibers. The anisotropic nature of composites allows airfoil 34 to be designed with different flexural stiffnesses in different directions based on the fiber orientation, quantity of plies, stacking sequence of plies and fiber stiffness. The tensile stiffness of airfoil 34 can also be controlled. Tensile strength depends on the fiber orientation, quantity of plies and fiber stiffness. Tensile stiffness is not affected by the stacking sequence.

Locally reinforcing tip region 44 with reinforcement plies 74B, 74D, 74G and 74I enables the chordwise stiffness of tip region 44 to be increased to reduce blade flutter while the spanwise stiffness of root region 48 is maintained to reduce damage from bird strikes. Further, by replacing a portion of plies 64B, 64D, 64G and 64I with reinforcement plies 74B, 74D, 74G and 74I having about the same thickness as primary plies 72B, 72D, 72G and 72I, the geometry of composite airfoil 34 is unchanged and the same mold for stacking and curing can be used without a tooling change to produce composite airfoil 34 with reinforced region 50 and a composite airfoil without reinforced region 50.

Adjustments of the stiffness of tip region 44 to reduce blade flutter can be based on finite element analysis of composite airfoil 34. With a given blade geometry, blade flutter is dependent on the stiffness and density of composite blade 32. Finite element analysis is used to determine the tip region stiffness that reduces blade flutter at specific frequency and mode ranges. Based on this stiffness, the number, composition and position of reinforcement plies 74 are determined. Local reinforcement of tip region 44 using reinforcement plies 74B, 74D, 74G and 74I provides an additional factor that can be adjusted to tune composite blade 32 and reduce or eliminate blade flutter.

Reinforcement plies 74 and primary plies 72 are separate plies that have different compositions, different fiber orientations or different compositions and different fiber orientations. In one example, reinforcement plies 74 are formed from a 90° uniweave boron/carbon hybrid material, and primary plies 72 are formed from a 0° uniweave carbon material. In FIG. 4, reinforcement plies 74 extend from primary plies 72 and are only located in tip region 44. Together primary plies 72 and reinforcement plies 74 form a locally reinforced airfoil ply. During production of composite airfoil 34, airfoil plies 64 and root plies 70 are stacked in a mold on either side of woven core 64 in an order specified in a lay-up schematic. Ply lay-up 68 shows the lay-up for airfoil plies 64 on pressure side 42 of composite airfoil 34. The lay-up for airfoil plies 64 on suction side 40 is a minor image about the centerplane of ply lay-up 68. After airfoil plies 64, primary plies 72, reinforcement plies 74 and root plies 70 are aligned in the lay-up, the mold is closed, resin is added if necessary and composite airfoil 34 is cured according to manufacture's instructions. For airfoil plies 64 comprising reinforcement plies 74 and primary plies 72, reinforcement plies 74 and primary plies 72 can be stacked as separate plies and the resin of composite airfoil 34 will bind the plies together to form composite airfoil 34.

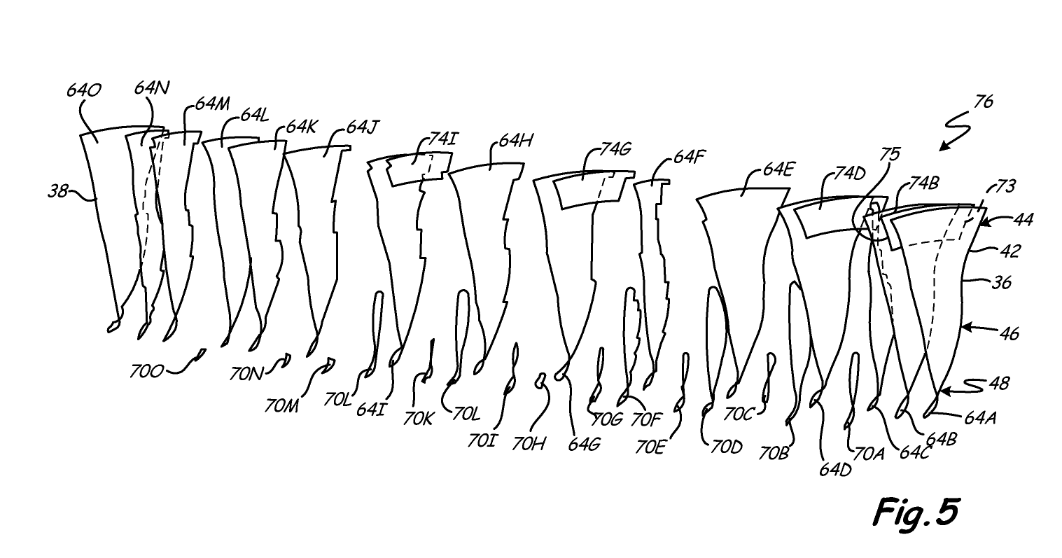

FIG. 5 is an exploded schematic view of an alternative example ply lay-up 76 having locally reinforced laminate region 50 formed by adding reinforcement plies 74 at tip region 44 of select airfoil plies 64. FIG. 5 is similar to ply lay-up 68 of FIG. 4, except that tip region 44 of select airfoil plies 64 are not removed and replaced with reinforcement plies 74. In lay-up 76, all airfoil plies 64A-64O (referred to generally as airfoil plies 64) extend to tip region 44, and reinforcement plies 74B, 74D, 74G and 74I (referred to generally as reinforcement plies 74) are positioned at tip region 44 between select airfoil plies 64. Reinforcement plies 74 each have leading edge 73 and trailing edge 75. In one example, leading edge 73 and trailing edge 75 of reinforcement ply 74B have about the same shape as leading edge 36 and trailing edge 38 of either airfoil ply 64A or 64B, which reinforcement ply 74B is positioned between. In another example, leading edge 73 and trailing edge 75 of reinforcement ply 74B have the same shape as leading edge 36 and trailing edge 38 of airfoil ply 64B.

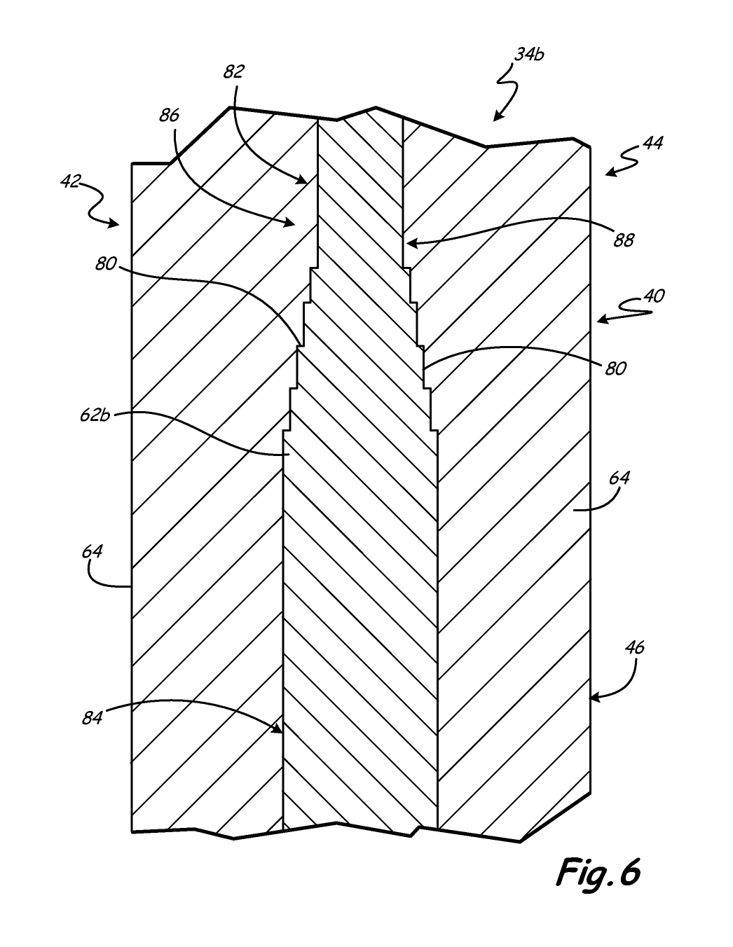

In layup 76, woven core 62 (shown in FIG. 6) is formed with a recess at tip region 44 corresponding to the size and shape of reinforcement plies 74. The recess in woven core 62 accommodates the additional thickness of reinforcement plies 74 so that composite airfoil 34 has the same geometry as an airfoil without reinforcement plies 74 and no tooling change is necessary. In one example, airfoil plies 64A, 64B, 64D, 64F, 64G, 64I, 64J, 64L and 64N are formed of 5 HS 0/90° woven fabric; airfoil plies 64E, 64H and 64O are formed of 5HS +/−45° woven fabric; airfoil plies 64C, 64K and 64M and root plies 70A-70O are formed of 0° uniweave material; and reinforcement plies 74B, 74D, 74G and 74I are formed of 90° uniweave material.

FIG. 6 is an enlarged cross-sectional view of composite airfoil 34b having recessed core 62b taken along the longitudinal axis of composite airfoil 34b. Airfoil plies 64 are positioned on either side of recessed core 62b. For clarity, each individual airfoil ply 64 is not shown. Woven core 62b includes recess 80, tip region 82, intermediate region 84, pressure side 86 and suction side 88. Woven core 62b is a three-dimensional woven structure. In one example, woven core 62b is formed of woven carbon fibers. Tip region 82 of woven core 62b is proximate tip region 44 of airfoil 34b and intermediate region 84 of woven core 62b is proximate intermediate region 46 of airfoil 34b. Recess 80 is formed at tip region 84 of core 62b on pressure side 86 and suction side 88.

Airfoil plies 64 are stacked on pressure side 86 of woven core 62b to form pressure side 42 of composite airfoil 34b, and airfoil plies 64 are stacked on suction side 86 of woven core 62b to form suction side 40 of composite airfoil 34b. As described above, reinforcement plies 74 can be inserted at tip region 44 between two adjacent airfoil plies 64 (see FIG. 5). Without recess 80, inserting reinforcement plies 74 in layup 76 would increase the thickness of composite airfoil 34b at tip region 44 and would require retooling of the composite blade mold. To eliminate the necessity to retool, recess 80 is configured to compensate for the additional thickness of airfoil 34b caused by reinforcement plies 74. Recess 80 also enables composite airfoil 34 having locally reinforced laminate region 50 to have the same geometry as a composite airfoil without locally reinforced laminate region 50.

Recess 80 is a void formed in tip region 82 of woven core 62b. Recess 80 can be a stair-stepped configuration such that multiple reinforcement plies 74 do not end at the same spanwise location. In one example, recess 80 is formed in woven core 62b when woven core 62b is fabricated or woven. When reinforcement plies 74 are positioned in lay-up 76, reinforcement plies 74 align with recess 80. Recess 80 is configured to have the same height, width and thickness as reinforcement plies 74. In this way, the additional thickness created by reinforcement plies 74 extends into woven core 62b and does not extend from the outer surface of airfoil 34b. Recess 80 enables reinforcement plies 74 to be added to airfoil 34b without changing the profile of the resulting composite airfoil 34b.

Recess 80 can be used in a similar manner to compensate for additional thickness due to reinforcement plies 74 in any type of ply lay-up. For example, woven core 62b having recess 80 can also be used in lay-up 68 when reinforcement plies 74 are thicker than airfoil plies 64. In such a case, recess 80 is sized to compensate for the difference in thickness between reinforcement plies 74 and airfoil plies 64 so that the addition of reinforcement plies 74 does not change the profile of composite airfoil 34b.

The vibration effects of blade flutter are driven by the stiffness and geometry of composite fan blade 32. By locally changing the lay-up of composite fan blade 32 at tip region 44, flutter can be reduced or eliminated. In the lay-ups presented in FIGS. 4 and 5, reinforcement plies 74 locally reinforce tip region 44 and form local reinforcement laminate region 50. Reinforcement plies 74 are used to adjust the chordwise stiffness of tip region 44. As discussed above, chordwise stiffness is affected by the orientation of the fibers, the quantity of plies, the stacking sequence of the plies and the fiber stiffness. Reinforcement plies 74 provide an additional factor that can be adjusted to optimize composite fan blade 32.

Reinforcement plies 74 also allow tip region 44 to be tuned while not affecting the stiffness of root portion 48. This allows previous optimizations made to root portion 48, such as improved protection against bird strike impacts, to be maintained. Further, the methods of locally reinforcing tip region 44 presented in FIGS. 4 and 5 maintain the geometry of composite blade 32 so that tool changes are not necessary in order to add reinforcement plies 74 to the layup.

While the invention has been described with reference to an exemplary embodiment(s), it will be understood by those skilled in the art that various changes may be made and equivalents may be substituted for elements thereof without departing from the scope of the invention. For example, although four reinforcement plies 74 were used in local reinforcement laminate region 50, local reinforcement laminate region 50 can comprise any number of reinforcement plies 74 such that local reinforcement laminate region 50 increases the chordwise flexural stiffness and chordwise flexural modulus of composite airfoil 34 compared to an airfoil not containing local reinforcement lamination region 50 and having plies 64 with uniform compositions from root region 48 to tip region 44. Additionally, reinforcement plies 74 can be positioned at any location in reinforcement tip region 44 and are not limited to the locations disclosed. Further, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A composite airfoil having a root, a tip, a tip region and a root region, the composite airfoil comprising:
a woven core extending between the root and the tip;
a first filament reinforced airfoil ply stacked on the woven core;
a second filament reinforced airfoil ply stacked adjacent to the first filament reinforced airfoil ply on the woven core; and
a local reinforcement laminate section at the tip region comprising a first reinforcement ply that does not extend to the root region, wherein the local reinforcement laminate section increases a chordwise flexural stiffness of the tip region.

2. The composite airfoil of claim 1, wherein the woven core comprises a recess having the same shape and thickness as the local reinforcement laminate section.

3. The composite airfoil of claim 1, wherein the first reinforcement ply is positioned between the first filament reinforced airfoil ply and the second filament reinforced airfoil ply.

4. The composite airfoil of claim 3, wherein the first filament reinforced airfoil ply has a first composition and a first fiber orientation and wherein the first reinforcement ply has the first composition and a second fiber orientation, a second composition and the first fiber orientation or the second composition and the second fiber orientation.

5. The composite airfoil of claim 1, wherein the first reinforcement ply aligns in a span-wise direction with a first filament reinforced airfoil ply to form a local reinforced ply extending between the root region and the tip region, and wherein the first filament reinforced airfoil ply has a first composition and a first fiber orientation and the first reinforcement ply has the first composition and a second fiber orientation, a second composition and the first fiber orientation or the second composition and the second fiber orientation.

6. The composite airfoil of claim 5, wherein the first filament reinforced airfoil ply has a thickness equal to a thickness of the first reinforcement ply.

7. The composite airfoil of claim 5, wherein the second fiber orientation is about 90 degrees.

8. The composite airfoil of claim 5, wherein the second composition comprises a high modulus carbon fiber and a low modulus carbon fiber.

9. The composite airfoil of claim 1, wherein the tip region is less than or equal to about 20% of a length of the airfoil.

10. The composite airfoil of claim 1, wherein a tip, a leading edge and a trailing edge of the first reinforcement ply aligns with a tip, a leading edge and a trailing edge of the first filament reinforced airfoil ply or the second filament reinforced airfoil ply.

11. The composite airfoil of claim 1, and further comprising a protective tip along the tip of the airfoil.

12. A method for forming a composite airfoil, the method comprising:
arranging a plurality of filament reinforced airfoil plies in a mold;
curing the airfoil plies in the mold to form a composite airfoil having a root region, a tip region and an intermediate region; and
locally reinforcing the tip region of the composite airfoil with a local reinforcement laminate section before curing the airfoil plies to increase a chordwise flexural stiffness of the tip region.

13. The method of claim 12, and further comprising the step of forming a woven core having a recess configured to accommodate the local reinforcement laminate section, and wherein the step of arranging a plurality of filament reinforced airfoil plies comprises arranging a plurality of filament reinforced airfoil plies on the woven core.

14. The method of claim 12, wherein the step of locally reinforcing the tip region comprises:
positioning a filament reinforcement ply at an end of a first filament reinforced airfoil ply, the filament reinforcement ply extending between the end of the first filament reinforced airfoil ply and a location in the tip region and the reinforcement ply having a different composition or a different fiber orientation than the first filament reinforced airfoil ply.

15. The method of claim 14, wherein the first filament airfoil ply and the filament reinforcement ply have about the same thickness.

16. The method of claim 14, wherein the local reinforcement laminate section has a fiber orientation of about 90 degrees.

17. The method of claim 14, wherein the local reinforcement laminate section as a composition comprising a high modulus carbon fiber and a low modulus carbon fiber.

18. The method of claim 12, wherein the step of locally reinforcing the tip region comprises:
positioning a filament reinforcement ply at the tip region of the composite airfoil between two adjacent filament reinforced airfoil plies.

19. The method of claim 12, wherein the step of locally reinforcing the tip region of the composite airfoil comprises locally reinforcing not more than about 20% of a length of the composite airfoil.
